(19) United States
(12) Patent Application Publication
(10) Pub. No.: US 2008/0220206 A1
(43) Pub. Date: Sep. 11, 2008

(54) Semiconductor die for increasing yield and usable wafer area

(76) Inventors: Ken Jian Ming Wang, San Francisco, CA (US); Ming Wang Sze, Ladera Ranch, CA (US)

Correspondence Address: FARJAMI & FARJAMI LLP, 26522 LA ALAMEDA AVENUE, SUITE 360, MISSION VIEJO, CA, 92691, US

(21) Appl. No.: 11/715,175

(22) Filed: Mar. 6, 2007

(51) Int. Cl. B32B 3/12

(52) U.S. Cl. 428/118

(57) ABSTRACT

According to one embodiment, a semiconductor die for increasing usable area of a wafer and for increasing yield has a substantially hexagonal shape. The wafer can have, for example, a circular shape. The semiconductor die can be diced by, for example, using a water-jet-guided laser. In one embodiment, the semiconductor die results in an approximately 2.0% to 4.0% reduction in the unusable area of the wafer. Moreover, the substantially hexagonal shape of the semiconductor die reduces stress at corners of the semiconductor die, thus increasing the yield of the wafer.

### BACKGROUND OF THE INVENTION

1. Field of the Invention

The present invention is generally in the field of semiconductors. More particularly, the present invention is in the field of semiconductor die fabrication.

2. Background

In conventional semiconductor device fabrication techniques, a number of uniformly shaped dies are designed on a semiconductor wafer. The dies are typically designed to have a square or rectangular shape for ease of manufacturability and dicing. As such, the dies are arranged in adjacent rows across a circular wafer in a grid configuration, so as to fit as many dies as possible on the wafer.

However, considerable portions of the wafer still remain unusable in such conventional semiconductor device fabrication techniques because the curved edge of the circular wafer prevents the accommodation of square or rectangular dies near the edges of the wafer. Since these unusable portions of the valuable wafer are discarded after singulation of the dies, a substantial amount of revenue can be lost during the fabrication of the dies.

Moreover, the square or rectangular dies that have a corner terminating near the edge of the wafer usually have lower integrity due to the stress imposed at the edges of the wafer. Consequently, such dies, even if fully formed and diced, have significantly higher failure rates than the dies situated away from the edges of the wafer.

### SUMMARY OF THE INVENTION

A semiconductor die for increasing the number of complete dies on a wafer, to increase yield and effective usable wafer area, substantially as shown in and/or described in connection with at least one of the figures, as set forth more completely in the claims.

### BRIEF DESCRIPTION OF THE DRAWINGS

FIG. 1 shows a number of conventional dies situated on a semiconductor wafer.

FIG. 2 shows a conventional die superimposed over a hexagonal die.

FIG. 3 shows a number of hexagonal dies situated on a semiconductor wafer in accordance with one embodiment of the invention.

FIGS. 4A and 4B show the corner stresses in a conventional die and a hexagonal die in accordance with one embodiment of the invention.

### DETAILED DESCRIPTION OF THE INVENTION

The present invention is directed to a semiconductor die for increasing the number of complete dies on a wafer, to increase yield and effective usable wafer area. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention.

The drawings in the present application and their accompanying detailed description are directed to merely exemplary embodiments of the invention. To maintain brevity, other embodiments of the present invention are not specifically described in the present application and are not specifically illustrated by the present drawings.

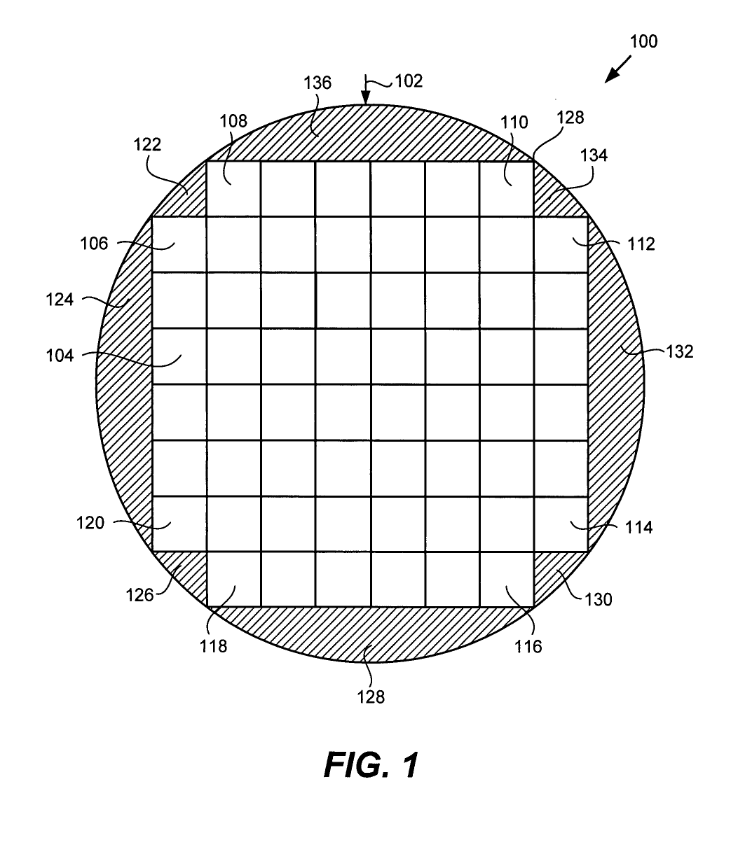

FIG. 1 shows a number of conventional dies situated on a semiconductor wafer. As shown in FIG. 1, wafer 100 includes a number of square conventional dies, such as die 104 (also referred to as “conventional dies 104”), and has edge 102 which extends around the circular perimeter of wafer 100. By way of another example (not illustrated in FIG. 1), conventional dies 104 might have a rectangular shape instead of a square shape. Wafer 100 can be a silicon-only wafer, but it could be a wafer of any other single or compound semiconductor material. As also shown in the example of FIG. 1, conventional dies 104 abut one another on wafer 100 and are arranged in a grid configuration.

As shown in FIG. 1, substantial portions of wafer 100, such as shaded portions 122, 124, 126, 128, 130, 132, 134, and 136 remain unusable because curved edge 102 of wafer 100 does not allow formation of another full die on shaded portions 122, 124, 126, 128, 130, 132, 134, and 136. Thus, because of the shape of conventional dies 104, large areas of wafer 100 are unusable and must be discarded after die singulation, resulting in a lower number of good dies from each processed wafer, and causing a loss of revenue.

As further shown in FIG. 1, the shape of conventional dies 104 also results in several of the conventional dies having a corner situated at edge 102 of wafer 100. For example, as shown in FIG. 1, conventional dies 106, 108, 110, 112, 114, 116, 118, and 120 of wafer 100 each have a corner situated at edge 102, such as corner 128 of conventional die 110. As discussed below, the shape of conventional dies 104 (in this example, the square shape) causes the dies to suffer high stress at the die corners. Consequently, a die having a corner situated at edge 102 of wafer 100 typically has a lower reliability due to, for example, stress imposed on edge 102 of wafer 100 during fabrication, and such a die is more likely to fail than the other dies on wafer 100. Moreover, stress at the corners of any square or rectangular die, whether at the edge of the wafer or near the center of the wafer, can increase the likelihood of failure of the die at the various stages of the fabrication process, e.g. die packaging, during which high stresses are imposed on the dies.

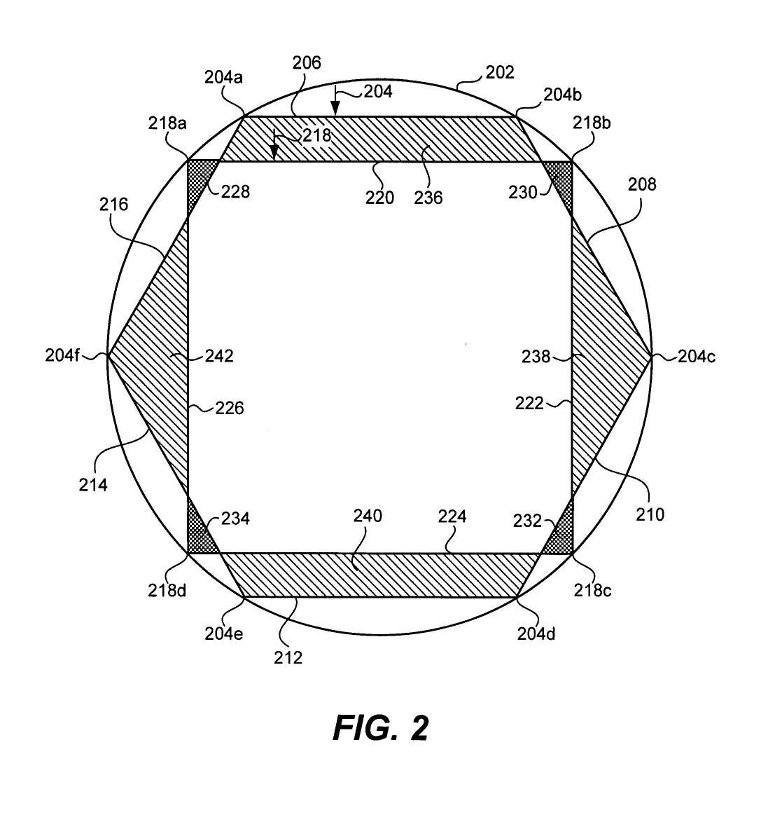

FIG. 2 shows a conventional square die superimposed over a hexagonal die, both circumscribed by circle 202 for the purpose of illustrating some of the concepts of the present invention. Circle 202 is shown as enclosing hexagonal die 204, which is defined by side 206 extending from corner 204a to corner 204b, side 208 extending from corner 204b to corner 204c, side 210 extending from corner 204c to corner 204d, side 212 extending from corner 204d to corner 204e, side 214 extending from corner 204e to corner 204f, and side 216 extending from corner 204f to corner 204a. As also shown in FIG. 2, circle 202 includes conventional square die 218, which is defined by side 220 extending from corner 218a to corner 218b, side 222 extending from corner 218b to corner 218c, side 224 extending from corner 218c to corner 218d, and side 226 extending from corner 218d to corner 218a.

As further shown in FIG. 2, hexagonal die 204 advantageously uses a substantially greater area of circle 202 than conventional square die 218. For example, hexagonal die 204 uses shaded portions 236, 238, 240, and 242 in addition to the area used by conventional square die 218, less corner portions 228, 230, 232, and 234 that are used by square die 218, but not by hexagonal die 204. Thus, FIG. 2 generally illustrates the concept that a hexagonal die makes a more efficient use of space within an enclosing circle. Although a square conventional die was used in FIG. 2 as one illustrative example, the difference in efficiency of use of space within a circular enclosure is even more pronounced when a rectangular die is compared to a hexagonal die.

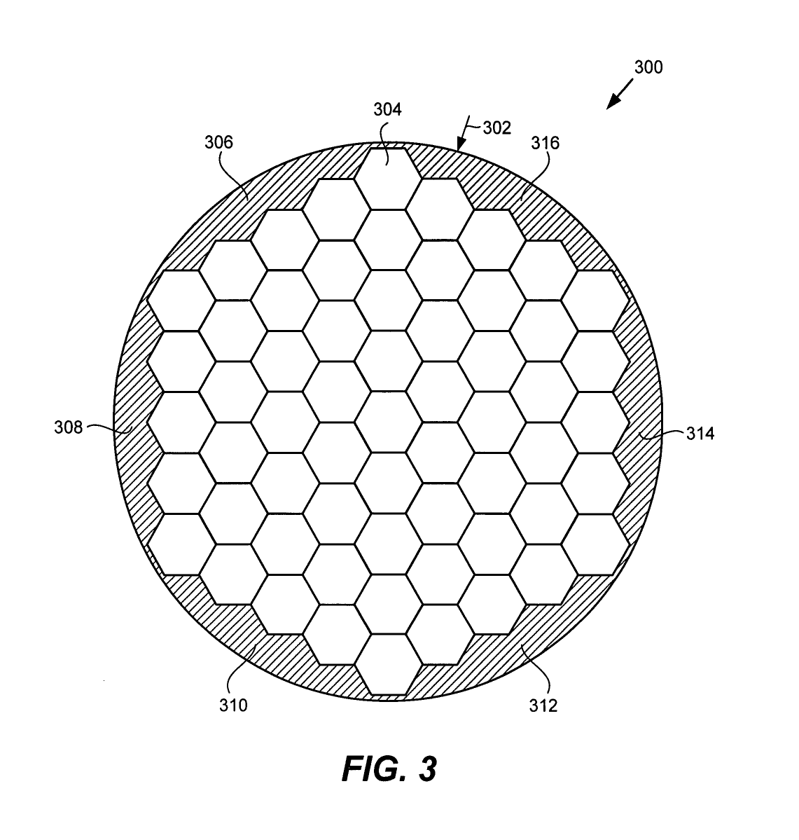

FIG. 3 shows a number of hexagonal dies situated on a semiconductor wafer in accordance with one embodiment of the invention. As shown in FIG. 3, wafer 300 includes a number of hexagonal dies, such as hexagonal die 304 (also referred to as “hexagonal dies 304”), which abut one another on wafer 300. As further shown in FIG. 3, wafer 300 has edge 302 which extends around the circular perimeter of wafer 300. Wafer 300 can be a silicon-only wafer, but it could be a wafer of any other single or compound semiconductor material, and the present invention is applicable regardless of semiconductor material used. In one embodiment, hexagonal dies 304 can each be a regular hexagon, i.e. a hexagon having sides of equal length. In other embodiments, the hexagonal dies can each be a non-regular hexagon. Each hexagonal die 304 can include, for example, a core having a hexagonal, rectangular, or square shape, or any other appropriate shape. As also shown in FIG. 3, hexagonal dies 304 advantageously reduce the unusable area of wafer 300 by using more of the area of wafer 300 as compared to conventional dies 104 of wafer 100 in FIG. 1. Thus, in referring to FIGS. 1 and 3, it can be seen that the total unusable area of wafer 300 in FIG. 3, i.e., the total area of unused portions 306, 308, 310, 312, 314, and 316, is significantly less than the total unusable area of wafer 100, i.e., the total area of portions 122, 124, 126, 128, 130, 132, 134, and 136.

Hexagonal dies 304 of the present invention can be conveniently diced using various die singulation processes. For example, hexagonal dies 304 can be diced using water-jet-guided laser technology, which involves the use of a low-pressure water jet that guides a laser beam. The water prevents thermal damage to the dies on the wafer as the laser beam cuts through the wafer. Accordingly, the water jet can be configured to follow the perimeters of hexagonal dies 304 on wafer 300 shown in FIG. 3, thereby allowing the laser to cut out each of the hexagonal dies.

As another example of achieving hexagonal dies 304, scribe lines can be formed around the respective perimeters of hexagonal dies 304 on wafer 300. Thereafter, a number of perforations are formed within the scribe lines using a low power laser beam. After the perforations are made, tension can be applied to wafer 300 to separate each hexagonal die 304 from wafer 300. Regardless of the approach taken to form and dice hexagonal dies 304, it is manifest that the invention's hexagonal dies 304 can be enclosed and used in various semiconductor packages after forming and dicing of the dies.

In addition to achieving greater use of the wafer area, the present invention results in dies that are more reliable due to reduced stress at the corners of the dies.

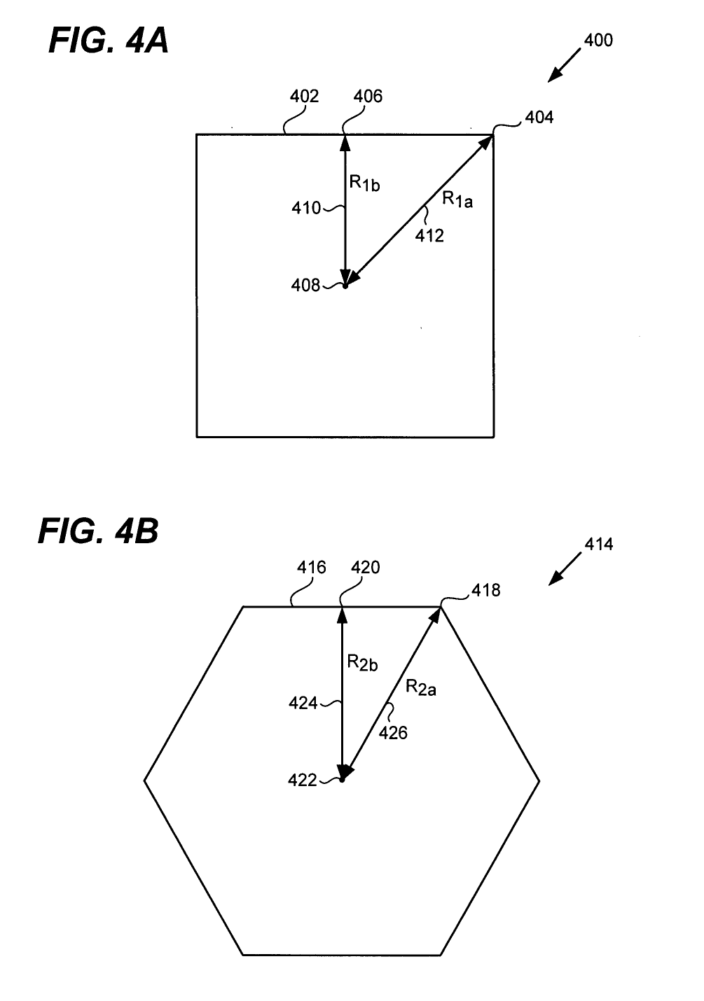

FIGS. 4A and 4B are used to compare the corner stresses of a conventional square die and a hexagonal die in accordance with one embodiment of the invention. FIG. 4A includes conventional square die 400, where distance 412 (also referred to as “R₁ₐ”) represents the distance from the center of conventional square die 400, i.e. center 408, to corner 404. Distance 410 (also referred to as “R_{1b}”) represents the distance from center 408 of conventional square die 400 to the center of side 402 situated at point 406. Rib represents the shortest distance from the center of conventional square die 400 to side 402.

FIG. 4B includes the present invention's hexagonal die 414. In FIG. 4B, distance 426 (also referred to as “R₂ₐ”) represents the distance from the center of hexagonal die 414, i.e. center 422, to corner 418 and distance 424 (also referred to as “R_{2b}”) represents the distance from center 422 of hexagonal die 414 to the center of side 416 situated at point 420. R_{2b} represents the shortest distance from the center of hexagonal die 414 to side 416.

Since the ratio R₂ₐ/R_{2b} for hexagonal die 414 of the invention shown in FIG. 4B is much closer to 1.0 compared to the ratio R₁ₐ/R_{1b} for conventional die 400 shown in FIG. 4A, the stress suffered at the corners of hexagonal die 414, e.g. the stress suffered at corner 418, is significantly lower than the stress suffered at the corners of the conventional die 400, e.g. the stress suffered at corner 404. By way of example, the ratio R₂ₐ/R_{2b} can be approximately 5.0% closer to 1.0 than the ratio R₁ₐ/R_{1b}. Although a square conventional die is used in FIG. 4A as one illustrative example, the ratio R₁ₐ/R_{1b} can be even smaller for a conventional rectangular die. Thus, the difference between the stress suffered at the corners of a conventional die and the stress suffered at the corners of the invention's hexagonal die can be even greater for a conventional rectangular die.

It is also noted that the corners of a die generally represent its highest stress points. As a consequence, reduction of stress at the corners has a profound effect on reducing die failure rate due to excessive stress imposed during, for example, semiconductor fabrication and packaging. Potential sources of such imposed stress include probe card testing, die singulation, general die handling (such as “pick and place” processes), injection molding, wire bonding, and die packaging processes.

As a result of the significant reduction in stress at the corners, hexagonal die 414 has a lower failure rate and greater reliability compared to conventional die 400. That is, even if hexagonal die 414 and conventional die 400 were both located near the respective centers of their respective wafers, or were otherwise located a “safe” distance from the respective edges of their respective wafers, hexagonal die 414 would have a lower failure rate and greater reliability since hexagonal die 414 can more easily withstand the different stress inducing processes during fabrication and packaging due to the reduced stress at the corners. As stated above, examples of such stress inducing processes include probe card testing, die singulation, general die handling (such as “pick and place” processes), injection molding, wire bonding, and die packaging processes.

Moreover, since the corners of the hexagonal dies of the invention experience lower stress than the corners of the conventional dies under similar conditions, the hexagonal dies near the edges of the wafer have substantially higher integrity than the conventional dies that have a corner situated at the edge of the wafer, such as conventional dies 106, 108, 110, 112, 114, 116, 118, 120, on wafer 100 in FIG. 1. As such, the hexagonal dies situated near the edges of a wafer are less likely to fail compared to the conventional dies situated near the edges of a wafer.

Thus, hexagonal dies 304 of the present invention provide significant advantages over conventional dies 104 shown in FIG. 1. Since hexagonal dies 304 of the invention significantly reduce the unusable area of a wafer as compared to the conventional dies, the present invention results in an increase in the number of dies that can be produced from a wafer. For example, hexagonal dies 304 can reduce the total unusable area created on a wafer by approximately 2.0% to 4.0%. Thus, the invention results in an increase in revenue from each produced wafer. The present invention also reduces the amount of semiconductor material discarded from each wafer and can therefore provide significant cost savings. Furthermore, the invention results in an increased yield due to the above-discussed reduced corner stress of the hexagonal dies.

From the above description of the invention it is manifest that various techniques can be used for implementing the concepts of the present invention without departing from its scope. Moreover, while the invention has been described with specific reference to certain embodiments, a person of ordinary skill in the art would appreciate that changes can be made in form and detail, and additional steps can be taken, without departing from the spirit and the scope of the invention. For example, it is manifest that the invention's hexagonal dies 304 can be enclosed and used in various semiconductor packages after dicing of the dies. Thus, the described embodiments are to be considered in all respects as illustrative and not restrictive. It should also be understood that the invention is not limited to the particular embodiments described herein but is capable of many rearrangements, modifications, and substitutions without departing from the scope of the invention.

Thus, a semiconductor die for increasing yield and usable wafer area has been described.

1. A semiconductor die for increasing a usable area of a wafer and for increasing yield, said semiconductor die having a non-regular hexagonal shape, thereby increasing said usable area of said wafer, wherein said non-regular hexagonal shape of said semiconductor die reduces stress at a corner of said semiconductor die, there by further increasing said yield;
wherein said semiconductor die is diced by forming a perforations within scribe lines around a perimeter of said semiconductor die.

2. The semiconductor die of clam 1 wherein said wafer is a substantially circular wafer.

3. The semiconductor die of claim 1 wherein said semiconductor die is diced using a water-jet-guided laser.

4-5. (canceled)

6. The semiconductor die of claim 1 wherein said scmiconductor die causes a greater than approximately 2.0% increase in said usable area of said wafer.

7. The semiconductor die of claim 1 wherein said. semiconductor die includes a substantially hexagonal core.

8. The semiconductor die of claim 1 wherein said semiconductor die includes a substantially rectangular core.

9. The semiconductor die of claim 1 wherein said semiconductor die is enclosed in a semiconductor package.

10. A semiconductor wafer having a plurality of non-regular hexagonal dies abutting one another so as to reduce unusable area of said semiconductor wafer, and so as to reduce stress at corners of said dies and so as to result in an increased yield of said semiconductor wafer; said semiconductor wafer having scribe lines thereon for forming perforations around a perimeter of each of said plurality of non-regular hexagonal dies.

11. The semiconductor wafer of claim 10 wherein corners of each said substantially hexagonal dies have a reduced stress.

12. The semiconductor wafer of claim 10 wherein said semiconductor wafer has a substantially circular shape.

13. The semiconductor wafer of claim 10 wherein said plurality of substantially hexagonal dies are diced using a water-jet-guided laser.

14-16. (canceled)

17. The semiconductor wafer of claim 10 wherein said dies cause at least 2.0% reduction in said unusable area of said semiconductor wafer.

18. The semiconductor wafer of claim 10 wherein each of said dies includes a substantially hexagonal core.

19. The semiconductor wafer of claim 10 wherein each of said dies includes a rectangular core.

20. The semiconductor wafer of claim 10 wherein said dies are enclosed in respective semiconductor packages.

21. The semiconductor die of claim 1 wherein said semiconductor die includes a substantially square shape core.

22. The semiconductor die of claim 10 wherein said semiconductor die includes a substantially square shape core.
